(19) United States
(12) Patent Application Publication
(10) Pub. No.: US 2006/0075974 A1
(43) Pub. Date: Apr. 13, 2006

(54) Insect proof food and/or water dish

(76) Inventor: Patrick Kennedy, Breckenridge, TX (US)

Correspondence Address: JACKIE JAY SCHWARTZ, 1350 Broadway, Suite 1510, NEW YORK, NY, 10018, US

(21) Appl. No.: 11/244,582

(22) Filed: Oct. 6, 2005

Related U.S. Application Data
(60) Provisional application No. 60/616,730, filed on Oct. 7, 2004.

(51) Int. Cl. A01K 5/01

(52) U.S. Cl. 119/61.5

(57) ABSTRACT

A device is disclosed for feeding pets and animals having a feeding section including a tip side and a depression formed in the top side for receiving food and/or water. A support section is connected to the feeding section for supporting the feeding section at a distance above a surface on which the device is positioned. An external surface of at least one of the feeding section and the support section is formed from a material having an ultra slick surface able to inhibit insects from being able to traverse the device.

### CROSS-REFERENCE TO RELATED APPLICATIONS

This is a non-provisional application of U.S. Provisional Patent Application Ser. No. 60/616, 730 filed on Oct. 7, 2004.

### FIELD OF THE INVENTION

The present invention relates generally to food and/or water dishes, and, more specifically, to a food and/or water dish and/or food and/or water dish holder mainly used by animals for inhibiting the ability of insects to enter the dish.

### BACKGROUND OF THE INVENTION

Numerous other animal feed dishes exist in the prior art. Specifically, conventional dishes use complicated multi-dish configurations with moats containing insecticides, soap, oils, etc. These dishes are all either impractical, cumbersome, dangerous and/or too expensive and thus are not widely used.

In the Southeastern and Southwestern United States, fire ants have reached dangerous infestation levels and animals are the most vulnerable to their stinging attacks. Animals that are stung inside their mouth suffer extreme distress and may die from choking. Since fire ants are equally as attracted to water and vegetable oils as they are to food, dishes with liquid moats create an attraction rather than a deterrent. The use of surfactants and/or insecticides in an area where animals and birds may seek food is also a further potential hazard. Where fire ants and other ants are present, it is typical for an animal owner to consistently destroy much of the food that is contained in traditional feeders.

Examples of prior art feeding systems are disclosed in U.S. Pat. No. 2,677,350 issued to Prestidge et al. and U.S. Pat. No. 4,357,905 issued to Carpenter. These patents each disclose dishes including a moat filled with an insecticide and/or water surrounding the food dish. This configuration not only requires a great deal of monitoring, but may create a dangerous situation for pets and birds if the liquid in the moat is spilled.

Another example is disclosed in U.S. Pat. No. 3,441,003 issued to DuMond et al. in which a dish contains an annular receptacle filled with an insecticide, and an upper receptacle filled with food. The dish disclosed herein places the insecticide and food in direct proximity to one another and therefore is not completely safe for the animal.

U.S. Pat. No. 533,017 issued to Peeler discloses a singular stand having a receptacle filled with water and or insecticide surrounding the stand and adjacent to the base thereof. This singular stand presents a greater propensity for the platform resting thereatop to tip. This increases the likelihood that the food and/or water will be contaminated with the insecticide and further infested by insects.

U.S. Pat. No. 4,128,080 issued to Haney and U.S. Pat. No. 4,966,099 issued to Arney rely on a method that actually attracts ants, and more specifically, will attract fire ants. Specifically, Haney describes using water positioned in a base and Arney describes using corn and/or vegetable oil. Haney operates on the premise that fire ants will be attracted if water is accessible. Arney uses corn and/or vegetable oil as an attractant to attract fire ants to this feeder.

While these patents accomplish the goals for which they were intended, none are able to accomplish the goals set forth hereinafter. Thus, it is desirable to produce a food and/or water dish for use by animals that is not dangerous to any living thing (including the insects). It is further desirable to produce a food and/or water dish that is adaptable for use with currently existing feed dishes and is able to prevent infestation of the food and/or water contained therein.

### SUMMARY OF THE INVENTION

The present invention relates generally to food and/or water dishes, and, more specifically, to a food and/or water dish and dish holder designed to prevent infestation thereof by insects.

It is a primary object of the present invention to provide a feeder for use by animals that overcomes the limitations of prior art food and/or water dishes.

It is a further object of the present invention to provide a feeder for use by animals that is designed to prevent insects from infesting the food and/or water retained therein.

It is still a further object of the present invention to provide a feeder for use by animals for providing at least one of food and water to animals typically kept as household pets as well as animals kept as livestock.

A yet further object of the present invention is to provide a feeder for use by animals that does not require the use of an insecticide or a repellant to prevent infestation by insects.

An even further object of the present invention is to provide a feeder for use by animals including a frame for supporting a container in which the at least one of food and water is dispensed therefrom.

A still further object of the present invention is to provide a feeder for use by animals wherein the frame includes a plurality of support members for maintaining the stability of the container supported thereby.

Another object of the present invention is to provide a feeder for use by animals wherein the plurality of support members are formed of a material having a slick surface or coated with a coating having a slick surface.

An even further object of the present invention is to provide a feeder for use by animals wherein the coating on the support members makes it difficult for insects to crawl on and/or traverse the support members.

A still further object of the present invention is to provide a feeder for use by animals wherein the insects are unable to traverse the coated support members and are thereby unable to come into contact with the at least one of food and water contained in the dish.

An even further object of the present claimed invention is to provide a feeder for use by animals wherein the stand includes a recess for retaining a fitted, included, dish or previously purchased pet food and/or water dishes therein.

Yet another object of the present invention is to provide a feeder for use by animals wherein the recess is of any geometric shape, and preferably is at least one of rectangular, square, oval and circular in shape.

Still another object of the present invention is to provide a feeder for use by animals including means for releaseably securing a conventional pet food dish within the recess.

A further object of the present invention is to provide a feeder for use by animals that is not harmful to any one of animals, people, the environment and any beneficial insects.

Another object of the present invention is to provide a feeder for use by animals that is simple and easy to use.

A still further object of the present invention is to provide a feeder for use by animals that is economical in cost to manufacture.

This invention is both sturdy and stable, thereby saving the food and/or water from spilling (in cases where animals are left alone and unattended) thereby assuring the owner that their animals are not hungry or thirsty.

Additional objects of the present invention will appear as the description proceeds.

The foregoing and other objects and advantages will appear from the description to follow. In the description, reference is made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWINGS

Various other objects, features and attendant advantages of the present invention will become more fully appreciated as the same becomes better understood when considered in conjunction with the accompanying drawings, in which like reference characters designate the same or similar parts throughout the several views.

FIG. 1 is a perspective view of the feeder for use by animals of the present invention;

FIG. 2 is a perspective view of the feeder for use by animals of the present invention having a circular shape;

FIG. 3 is a top view of an adapter for use with the feeder for use by animals of the present invention as shown in FIG. 2;

FIG. 4 is a perspective view of the feeder for use by animals of the present invention as shown in FIG. 2 including the adapter of FIG. 3 positioned thereatop;

FIG. 5 is a top view of an adapter for use with the feeder for use by animals of the present invention shown in FIG. 1;

FIG. 6 is a perspective view of the feeder for use by animals of the present invention including a slideable divider to produce two adjustable retaining pools for food and water;

FIG. 7 is a perspective view of the feeder for use by animals of the present invention having support members for retaining a container therein;

FIG. 8 is a perspective view of an alternate embodiment of the feeder for use by animals of the present invention including a recess for receiving food dishes therein;

FIG. 9 is a perspective bottom view of the feeder for use by animals of the present invention shown in FIG. 8;

FIG. 10 is a perspective view of the underside of the feeder for use by animals of the present invention shown in FIG. 8 having the support members in a retracted position;

FIG. 11 is a partial cross-sectional view of the feeder for use by animals of the present invention taken along the line labeled 11-11 in FIG. 8;

FIG. 12 is a partial cross-sectional view of the feeder for use by animals of the present invention taken along the line labeled 12-12 in FIG. 18; and

FIG. 13 is a perspective view of the feeder for retaining two dishes in accordance with the present invention.

### DETAILED DESCRIPTION OF THE PREFERRED EMBODIMENT

The present invention is a feeder for use by animals which are treated with a slick material such as Teflon PTFE 30 and/or an ultra slick coating material. The coating material may utilize nano-tube technology to increase the slickness and durability of the container. The invention provides a surface on at least a portion of the length and diameter of the feeder which is difficult for ants and other crawling insects to traverse or climb. The invention therefore, creates a safe feeding or watering device for pets, livestock or domestic animals. More importantly the invention conveys a low cost and simple food or water feeder, intended to prevent infestation by dangerous and painful fire ants and other insects.

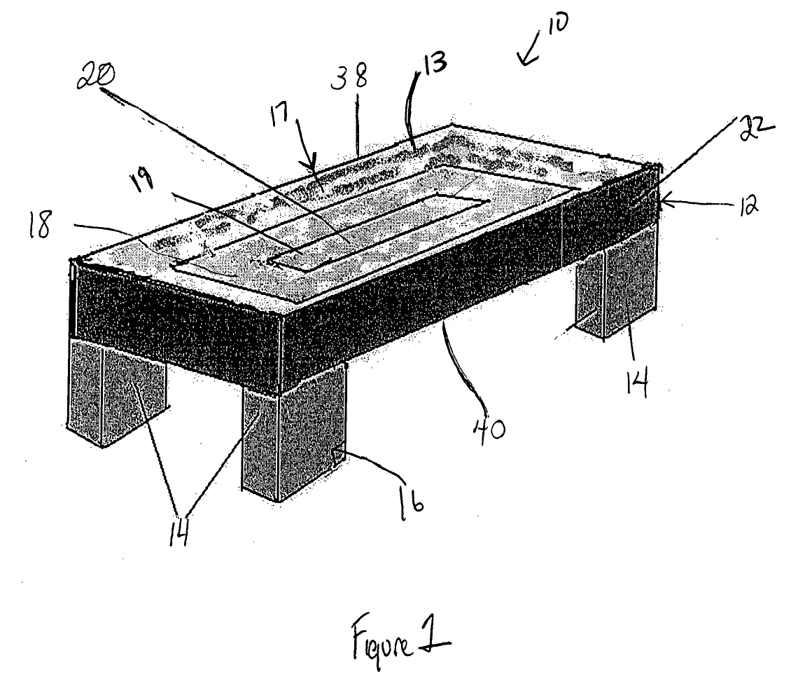

Turning now descriptively to the drawings, in which similar reference characters denote similar elements throughout the several views, FIGS. 1 through 13 illustrate the insect-proof feeder of the present invention indicated generally by the numeral 10.

FIG. 1 is a perspective view of the feeder 10 of the present invention. The feeder 10 of the present invention includes a frame 12. The frame 12 is formed from a support section 16 and a feeding section 17 connected thereto. The feeding section 17 includes a top side 38 and a bottom side 40. The feeding section 17 is connected to the support section 16 at the bottom side 40. An exterior wall 22 extends from the top side 38 towards the support section 16. A depression 20 forming a pool is formed in the top side 38. The depression 20 includes a side wall 18 extending from the top side 38 and around the depression 20 and a base 19. The depression 20 is illustrated having a rectangular shape in substantially the center of the top side 38 for receiving either food, water or a container therein. The container will sit atop the base 19 and is surrounded by the side wall 18. A wall 13 extends between the side wall 18 and the exterior wall 22. A rim of the container received by the depression 20 is able to rest on the wall 13 when positioned in the depression 20, thereby providing additional support for the container. The depression 20 or container is able to retain at least one of food and water therein for dispensing to animals. The container may be selectively separable from the frame or formed integrally with the frame 10. When formed separable from the frame 12, the container may be easily removed therefrom for cleaning and re-filling. This is particularly advantageous in that a user can utilize a previously purchased pet food and/or water dish with the feeder 10 of the present invention. The use of a container also eliminates the need for cleaning the entire dish 10 of the present invention. The support section 16 includes support members 14. The support members 14 extend from and act to support the feeding section 17. The support members 14 act to support the feeder 10 above any surface on which it is placed.

The frame 12 of the feeder 10 of the present invention is shown in FIG. 1 having a rectangular shape. This shape is shown for purposes of example only and the frame may be formed in any geometric shape. An exterior surface of the frame 12 may be formed from any material able to support and maintain the feeding section a distance above any surface on which the frame is positioned including but not limited to at least one of fiberglass, steel, plastic, metal and wood. The frame is either fromed from a material having an ultra-slick surface or the exterior surface of the frame is coated with an ultra-slick coating, such as Teflon. The ultra-slick coating aides in preventing insects from accessing the container of the feeder 10 of the present invention. Alternatively, the frame may be formed from an ultra-slick material such as Teflon.

The support members 14 are used for raising the feeding section 17 a predetermined height off a surface on which the feeder 10 is positioned. Preferably, the predetermined height is equal to or greater than two inches. The height at which the feeder extends above the surface is able to minimize the possibility of insects and ants crawling up the support members 14 while also not inhibiting the ability of the animal to eat. As shown herein, there are four support members 14 positioned extending from the bottom side 40 of the frame 12 at each respective corner thereof. The support members 14 are shown for purposes of example only and any number of support members 14 may be included to ensure the stability of the feeder 10. The support member(s) may also be releasably or pivotably secured to the frame 12. The support members 14 have an external surface 16 thereof coated with an ultra-slick coating, such as Teflon. This coating on the support members 14 prevent any insects that crawl from ascending the support members 14 and accessing the container and any food and/or water retained therein. Alternatively, the support members are at least one of treated with an ultra slick coating material, which may utilize nano-tube technology, plated with Teflon and having Teflon fused thereto. Additionally, is it preferable that the Teflon for use with the feeder 10 of the present invention is Teflon PTFE30. The Teflon may be glazed and/or baked onto the legs or supports by a heating process.

As the insects attempt to crawl up a support member 14 of the feeder 10 of the present invention, the coating prevents the legs and pincers of the insect from adhering thereto and gravitational force causes the insect to slide down the support member 14 in a direction away from the feeding section and towards the surface on which the feeder 10 is resting.

The feeder 10 of the present invention may be formed from at least one of stainless steel or other metal, injection molded plastic or other plastic material. The depression 20 when formed in a square shape preferably has dimensions within a range of between six inches by six inches and twelve inches by twelve inches squared and ranging between four inches and eight inches in depth. A depression 20 having a rectangular shape preferably has dimensions within a range between four inches wide by eight inches long and between ten inches wide by sixteen inches long having a depth ranging between four inches and eight inches.

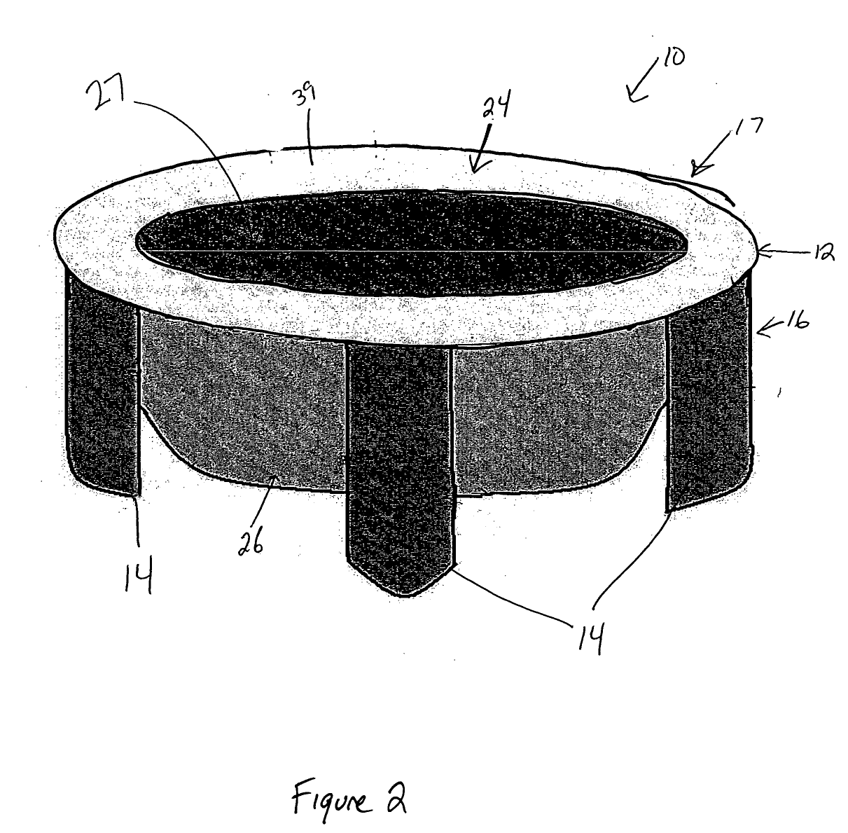

FIG. 2 is a perspective view of the feeder 10 of the present invention having a circular depression formed therein. The frame 12 as shown herein includes a support section 16 and a feeder section 17. The feeder section 17 circular top side 24. The support section 16 includes a plurality of support members 14. The plurality of support members 14 extend from the top side 24. The support members 14 may be positioned equidistant from one another and around the periphery of the top side 24. The equidistant positioning provides balance and support for a container which may be retained thereby and prevents unwanted tipping of the feeder 10. However, the support members 14 may be positioned at any position extending from the top side which is able to feeding section 17.

A circular depression 27 extends into a central portion of the top side 24 forming a pool 27 therein. The depression 27 is formed by a semi-circular wall 26 extending from a same side of the top side 24 as the support legs 14. The depression 27 may receive a circular or rounded container therein. Alternatively, food can be placed directly in the depression. When a container is placed in the depression 27 a rim of the container will rest on a ridge 39 of the top side 24 thereby supporting the container. The container is preferably maintained at least two inches from the surface on which the frame 10 is positioned in order to space the container from the surface on which the feeder 10 is placed and prevent insects from crawling thereon. Prevention of insect infestation is further ensured by the support members 14 being coated in at least one of Teflon and an ultra-slick coating material. Alternatively, an exterior surface of the frame 12 may also be formed from or coated with at least one of Teflon and another ultra-slick material.

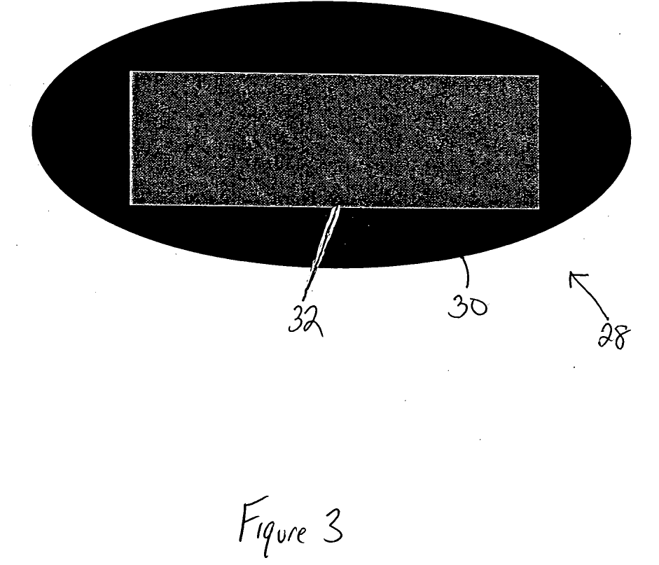

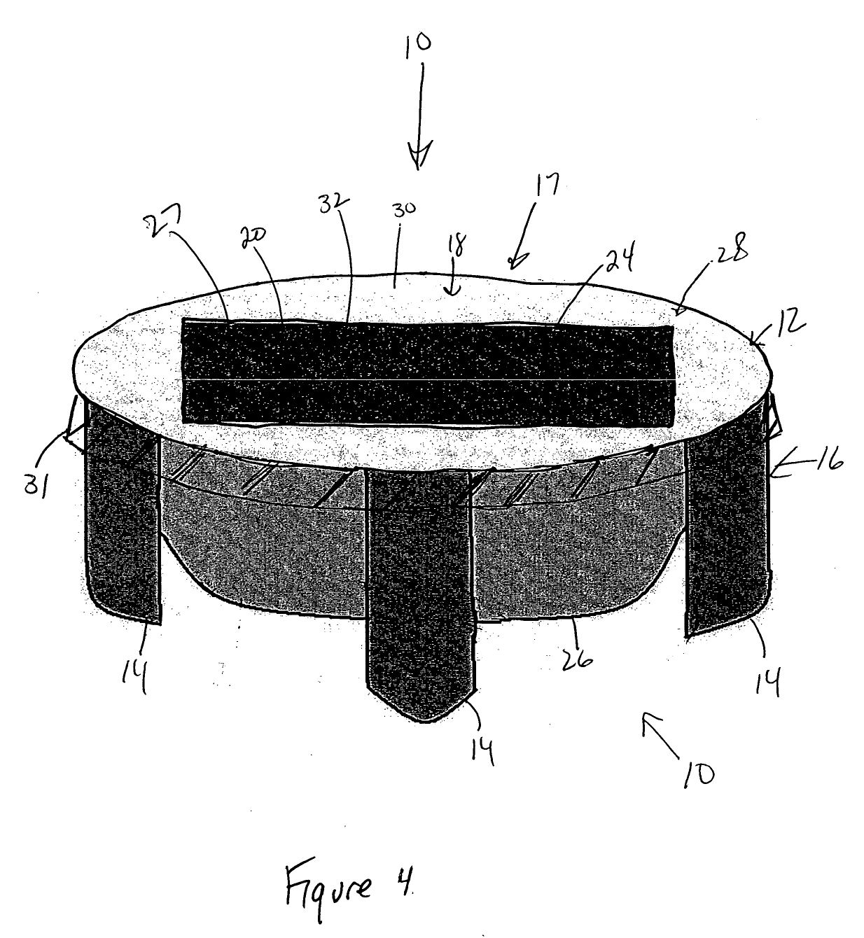

FIG. 3 is a top view of an adapter 28 for use with the feeder 10 of the present invention as shown in FIG. 2. The adapter 28 is substantially circular in shape and is able to be secured atop the depression 20. The adapter 28 is formed by a plate 30 having a recess 32 extending therethrough. The plate 30 is of a size able to sit atop the ridge 18 of the top side 24 as shown in FIG. 2. A rim (shown in FIG. 4 and denoted by Reference numeral 31) may extend from the periphery of the plate 30 for aiding in securing the adapter 28 to the frame 10. The recess 32 may be positioned at substantially a center point of the plate 30 and have a geometric shape different from the shape of the depression 20 thereby allowing the frame to be used with pre-existing pet food containers 20 having a different shape from the depression 20. As shown herein, the recess 32 is rectangular in shape. However, the recess 32 may be formed in any geometric shape. The adapter 28 allows the user to use any number of previously purchased pet food dispensing containers with the dish 10 of the present invention.

FIG. 4 is a perspective view of the feeder 10 of the present invention as illustrated in FIG. 2 including the adapter 28 positioned thereatop to allow for use with a rectangular pre-existing food container. As shown herein the adapter 28 is positioned atop the top side of the frame thereby allowing for use of the frame with containers of rectangular shape.

The plate 30 is circular and covers the top side 38 of the feeder. The rim 31 extends around an outer periphery of the plate 30 and forming a skirt hanging over the top side and substantially parallel to the support members 14 for releasably securing the plate 30 to the feeder 10. A ridge 18 is formed around the edge of the recess 32 and above the depression 20 for receiving the adapter 28 thereon and retaining a container within the depression 20. The recess 32 is at least one of substantially square and substantially rectangular in shape. The pool formed by the depression 20 extends from the top side and is positioned a distance above the surface. The pool and is able to receive the container which is inserted through the recess 32. The embodiment shown herein is able to receive a previously purchased square or rectangular pet food and/or water container therein. Alternatively, the recess 32 may be of any geometrical shape for receiving a container of any desired shape. Prevention of insect infestation is further ensured by the support members 14 being coated in at least one of Teflon and an ultra-slick coating material. Additional protection from infestation is provided by the pool being positioned between the surface and the container. Insects and ants must first pass through the pool before they are able to infest the container in which food is positioned.

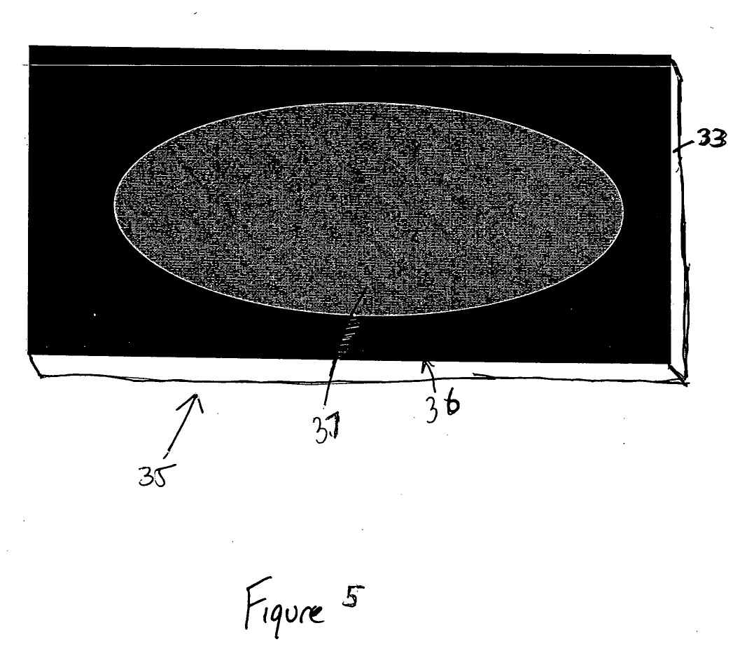

FIG. 5 is a top view of an alternate adapter 35 for use with the feeder 10 of the present invention as shown in FIG. 1. The alternate adapter 35 is at least one of substantially rectangular or substantially square in shape and is able to be received and secured over the depression 20 having a corresponding shape. The adapter 35 is formed by a plate 36. A securing lip 33 extends around the periphery of the plate 36 for releasably securing the adapter 35 to the top side 20 of the feeder 10. The adapter 35 further includes a recess 37 positioned at a substantially central region of the plate 36. The adaptor recess 37 has a geometric shape different from the shape of the depression 20 and allows a user to retain a pre-existing pet food container shaped like the adaptor recess 37 in the feeder 10. As shown herein, the adaptor recess 37 is substantially oval in shape. However, the adaptor recess 37 may be formed in any geometric shape.

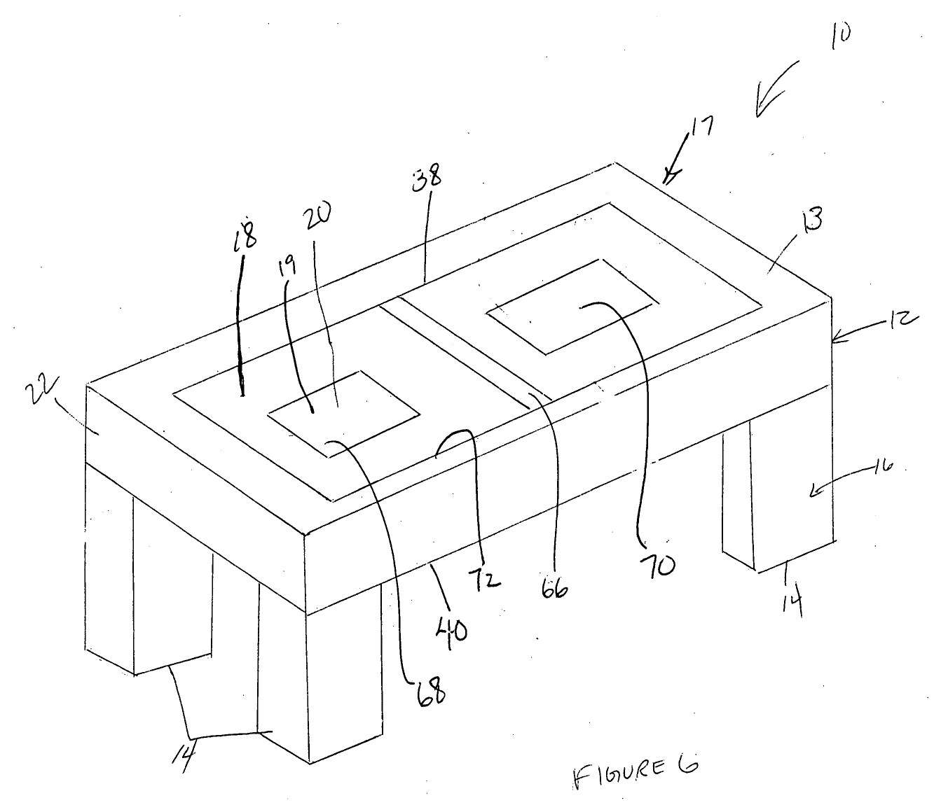

FIG. 6 is a perspective view of the feeder 10 of the present invention as shown in FIG. 1 which is able to retain multiple rectangular pre-existing food dishes. In this embodiment, the feeder 10 includes a dividing bar 66 slideably positioned to extend between sides of the top side 38 and across the depression 20. The dividing bar 66 sits within a track 72 formed in the depression 20 and divides the depression 20 into first and second receiving sections 68 and 70, respectively. The first and second receiving sections 68 and 70, respectively, each form a pool for receiving either a container shaped to fit the respective section or food/water therein. The sliding dividing bar 66 may be moved along the track and thus the length of the depression 20 to adjust the dimensions of the first and second receiving sections 68 and 70. The dividing bar 66 may extend to the base of the depression thereby providing receptacles for receiving either food/water or a container. The dividing bar 66 moves along the track 72 thereby adjusting the dimensions of the first and second sections of any desired size. The dividing of the depression allows two containers to be received therein. This is advantageous as it allows for use of only one feeder 10 to fit two containers side by side, thereby allowing the user to have both food and water retained by the feeder 10. Alternatively, the placement of the dividing bar 66 can be adjusted to secure one container 20 in the container depression 20 that is smaller than the container depression. This is advantageous as it allows for placement of different size containers in the dish 10. If the containers are not formed integrally with the feeder 10 they may be easily removed for cleaning and re-filling the at least one of food and water.

The frame 12 of the feeder 10 of the present invention is shown in FIG. 6 having a rectangular shape. This shape is shown for purposes of example only and the frame may be formed in any geometric shape that is able to maintain and secure the at least one container therein. The exterior surface of the frame 12 may be formed from at least one of fiberglass, steel and wood, and is coated with at least one of Teflon and an ultra-slick coating for preventing insects form contaminating the at least one of food and water retained therein.

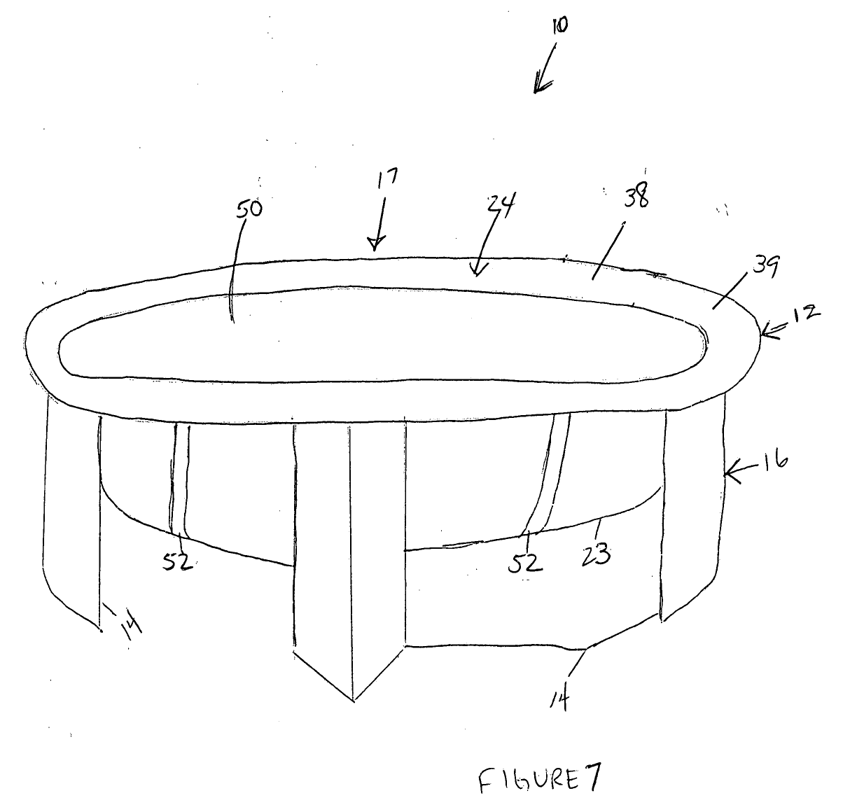

FIG. 7 is a perspective view of the feeder 10 of the present invention for use with a circular pre-existing container. The frame 12 as shown herein is circular in shape and an aperture 50 is provided in place of the depression 27 shown in FIG. 2. Support members 52 extend below the top side 38 and across the aperture 50 for supporting a container 23 placed in the aperture 20. The support members 52 extend in an arced manned across the aperture 20 on the same side of the top side 38 as the support section 16. The support members 38 are provided for retaining pet food and/or water container that does not have a rim extending around the periphery thereof. A rim of the container may be supported by the wall 13 surrounding the aperture 50. Any number of support members 52 may be provided extending across the circumference of the aperture 20 as long as the support members are able to support a container 23 positioned within the aperture 50. The support members 52 extend in any manner able to retain a container a distance above the surface on which the feeder 10 is positioned. The container 20 is received through the container aperture 50 such that a base of the container 23 is in contact with the support members 52 and sits below the top side 38. The support members 52 may be made of a material with some elasticity to allow the container 20 to be nestled in the feeder 10 as opposed to resting on the surface of the feeder 10. The base of the container 23 is preferably maintained at least two inches from the surface on which the feeder 10 is resting in order to prevent insects from crawling thereon.

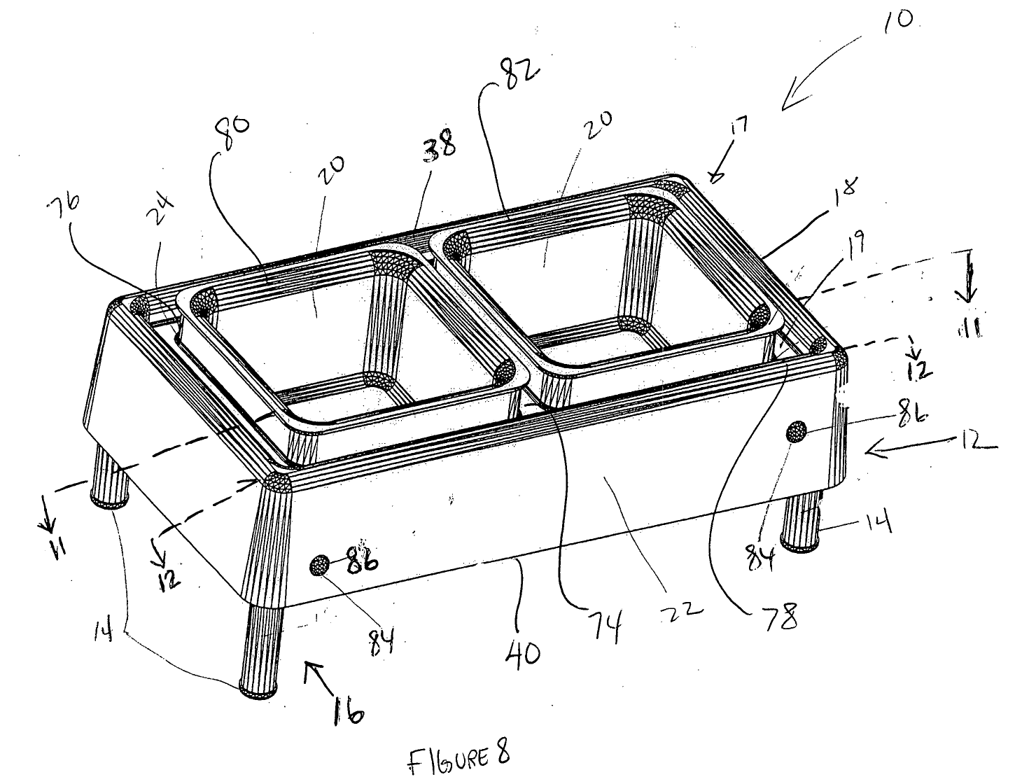

FIG. 8 is a perspective view of the feeder 10 of the present invention as shown in FIG. 1 and including two apertures 76 and 78 extending through the depression 20. First and second containers 80 and 82 are shown retained within the first and second apertures 76 and 78, respectively. As can be seen from this figure, the frame 12 of the feeder 10 is rectangular in shape. This shape is shown for purposes of example only and the frame may be formed in any geometric shape that is able to maintain and secure a container therein. The feeder 10 is similar to that shown in FIGS. 1 and 6. An aperture extends through the top side and a stationary dividing rod 74 extends across the aperture dividing the aperture into first and second recesses 76 and 78. First and second containers 80 and 82 are shown seated within the first and second recesses 76 and 78, respectively, and resting above the level of the top side 24. The first and second containers 80 and 82 are each provided for receiving water and/or food. Shown herein, the first and second apertures 76 and 78 are square in shape to receive first and second containers 80 and 82 that are also square in shape. As discussed above, the shapes shown are for purposes of example only and the apertures 76 and 78 and the containers 80 and 82 may be formed in any geometric shape.

The support section 16 includes a plurality of legs 14. The legs 14 are pivotably connected to the feeding section 17. The pivotable legs 14 extend from each corner of the bottom side 40 of the feeding section 17. Each leg 14 is pivotally attached to the feeding section 17 by a respective pin 84 which extends through a respective pin aperture 86 postioned in the exterior wall 22 of the feeding section 17. The pin aperture 86 is located proximate to each corner of the exterior wall 22 and extends through the exterior wall 22.

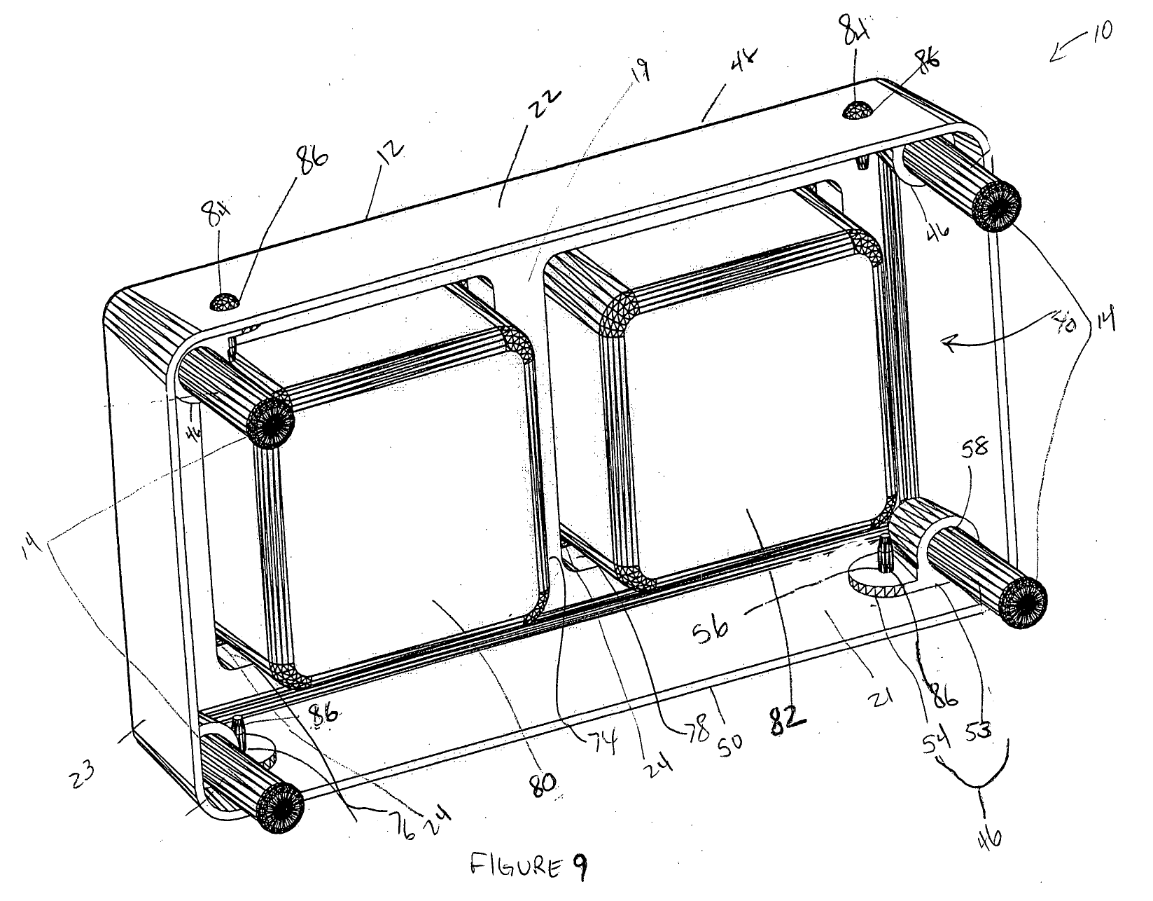

FIG. 9 is a perspective bottom view of the feeder 10 having the legs 14 in an extended position. As can be seen from this figure, the first and second containers 80 and 82 are positioned within the first and second recesses 76 and 78, respectively. The pin aperture 86 is located proximate to each corner of the exterior wall 22 and extends therethrough. Positioned in each corner of the exterior wall 22 on an inside 21 thereof is a support bracket 46. Each support bracket 46 includes a housing 53 and a tab 54 extending from the housing 53. The tab 54 includes a recess 56 extending therethrough. The recess 56 is aligned with the recess 86 and receives the pin 84 therethrough for pivotably securing the support bracket 46 to the exterior wall 22. The housing 53 is positioned adjacent to the inside 21 corner of the exterior wall 22. The housing 53 includes a support member aperture 58 for receiving one end of a respective leg 14 therein. Alternatively, the leg 14 can be formed integral with the housing 53. The support bracket 46 pivots about the pin 84 for extending and retracting the leg 14. Shown herein, the legs 14 are in the extended position.

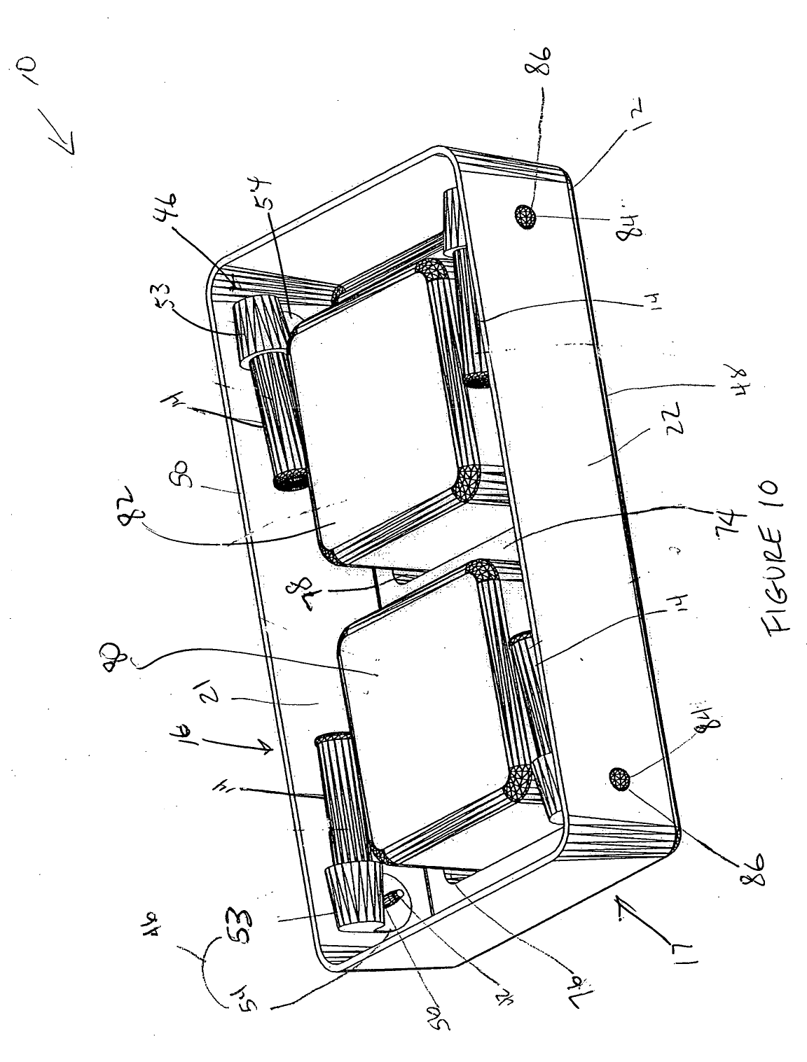

FIG. 10 is a perspective view of the underside of the feeder 10 of the present invention as described hereinabove with specific reference to FIG. 9. Shown herein, the legs 14 are positioned in the retracted position. The legs 14 have been pivoted along with the support bracket 46 about the pin 42 to retract the legs 14 for easy storage of the feeder 10. The support bracket 46 pivots about the pin 84 until the leg 14 no longer extends beyond the exterior wall 22 of the frame 12.

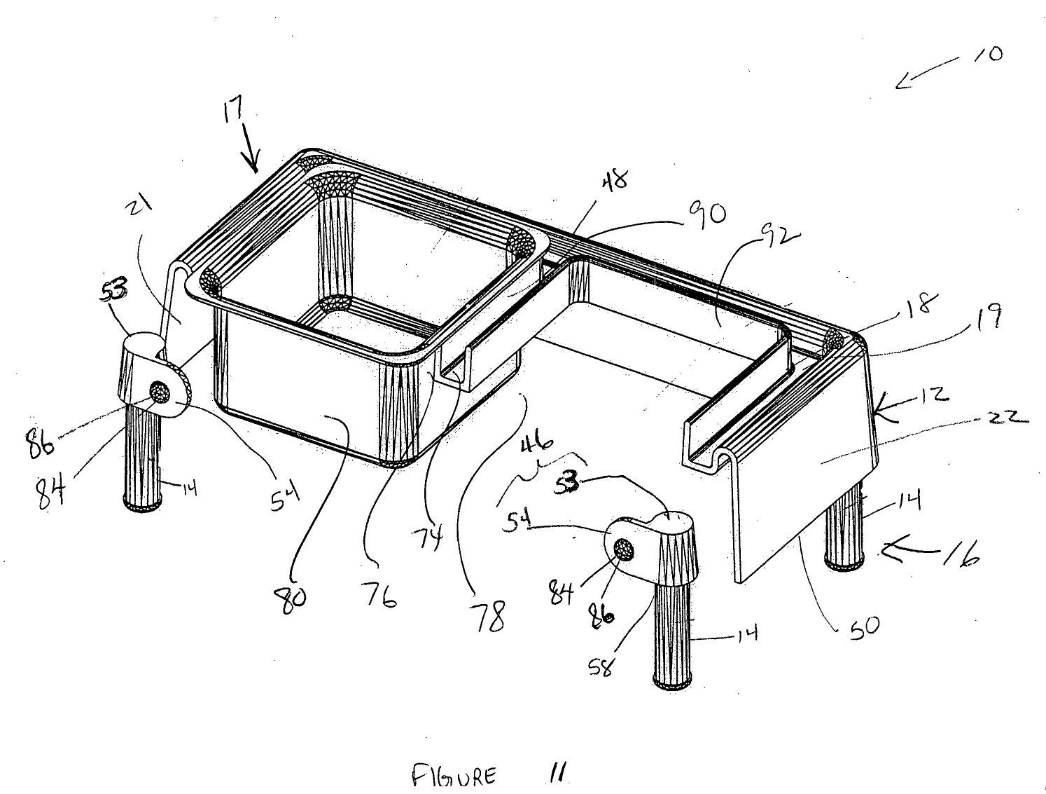

FIG. 11 is a partial cross sectional view of the feeder 10 of the present invention taken along the line 11-11 in FIG. 8. Shown herein, only one container 76 is positioned within an aperture 80. Two of the four support brackets 46 and legs 14 are shown unattached to the frame 12. The support bracket 46 includes the housing 53 and the tab 54 extending from the housing 53. The housing 53 is positioned adjacent to the inside 21 corner of the frame 12 when the leg 14 is in the extended position, as shown herein. One end of the leg 14 is received by the support member aperture 58 in the housing 53. Alternatively, the support member 14 can be formed integral with the housing 53. The pin 86 is received by the tab aperture 56 in the tab 54. The tab aperture 56 is located substantially in the center of the tab 54 and aligned with the pin aperture 84. As shown in FIG. 11, when the tab aperture 56 is aligned with the pin aperture 84, the pin 86 is inserted therethrough to pivotally attach the support bracket 46 to the inside 21 of the frame 12. As can be seen from this figure, the divider 74 is positioned between the first and second apertures 76 and 78, respectively. Each of the first and second apertures 76 and 78 includes a wall, 90 and 92, respectively, extending therefrom in a direction opposite the supporting section 17 forming a lip for retaining a container positioned into each respective aperture at a height above the aperture. A pool is also formed around the first and second apertures and including the dividing bar 74 for catching any food or water which may overflow the first and/or second containers.

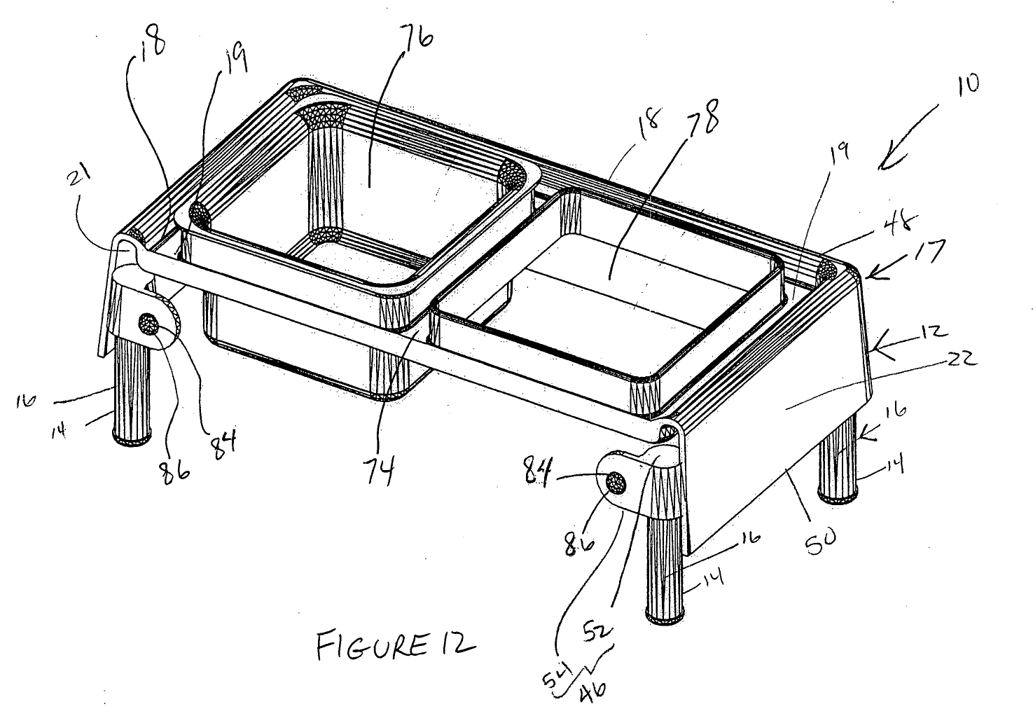

FIG. 12 is a partial cross sectional view of the feeder 10 of the present invention taken along the line 12-12 in FIG. 8. This Figure is provided to show that the walls 90 and 92 completely surround their respective apertures 76 and 78 to form a pool between the walls 90 and 92 and the side wall 18.

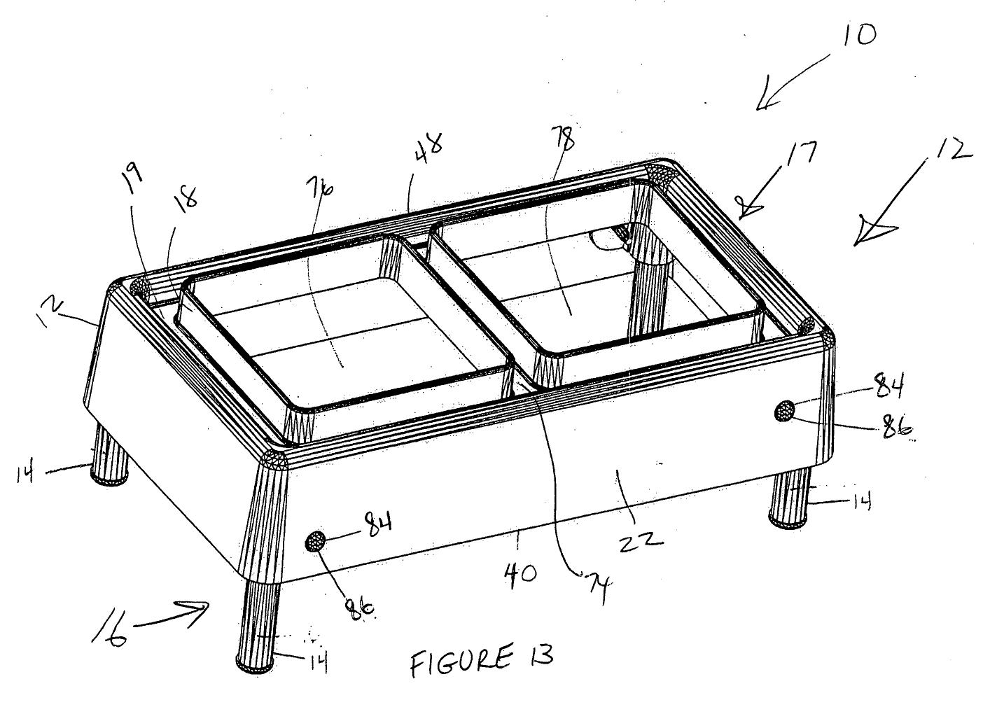

FIG. 13 is a perspective view of the feeder 10 as shown in FIG. 12 without containers positioned within the first and second apertures 76 and 78.

This invention has been tested by applicant in a heavily infested fire ant area. During this test period, many different types of dry and canned dog and cat food as well as water were tested and although thousands of ants attempted entry, no ants were able to climb the treated legs to access the food or water. There were no ill effects in any pets or any other living thing from the use of the container and or holder. The invention's stability and ability to handle any type of weather were excellent.

The feeder 10 of the present invention may additionally be formed as a domestic or wild animal or bird tray which may have recessed regions, configured to hold at least one of a circular, square and rectangular commercially produced domestic or wild animal or bird tray therein. The feeder 10 is elevated off a ground surface by a plurality of supports, each of which is treated with an ultra slick coating material, which may utilize nano tube technology, and/or a Teflon material such as Teflon PTFE 30.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. A device for feeding pets and animals, comprising:
a feeding section including a tip side and a depression formed in the top side for receiving food and/or water;
a support section connected to said feeding section for supporting said feeding section at a distance above a surface on which the device is positioned, wherein an external surface of at least one of said feeding section and said support section is formed from a material having an ultra slick surface able to inhibit insects from being able to traverse the device.

2. The device of claim 1, wherein the material is TEFLON®.

3. The device of claim 1 wherein said support section includes at least one leg.

4. The device of claim 3, wherein said at least one leg is pivotally connected to said feeding section.

5. The device of claim 1, wherein said feeding section further includes at least one aperture extending through said top side within said depression.

6. The device of claim 5, wherein said aperture is sized to selectively receive a container for receiving food and/or water.

7. The device of claim 5, further including a dividing bar positioned to extend across said aperture, thereby forming first and second recesses for selectively receiving first and second containers therein.

8. The device of claim 7, wherein said dividing bar is slideably positioned within said aperture for selectively adjusting the size of the first and second recesses.

9. The device of claim 5, wherein said aperture further includes a wall extending therearound on a side of the top side opposite said support section
